(19) United States
(12) Patent Application Publication
(10) Pub. No.: US 2026/0077631 A1
(43) Pub. Date: Mar. 19, 2026

(54) VEHICLE HEAT MANAGEMENT SYSTEM

(71) Applicant: Hanon Systems, Daejeon (KR)

(72) Inventors: Jae Min LEE, Daejeon (KR); In Keun KANG, Daejeon (KR); Young Man KIM, Daejeon (KR); In Hyeok KIM, Daejeon (KR); Jae Kyun KIM, Daejeon (KR); Kyeong Cheol LEE, Daejeon (KR)

(73) Assignee: Hanon Systems, Daejeon (KR)

(21) Appl. No.: 19/101,213

(22) PCT Filed: Oct. 10, 2023
(86) PCT No.: PCT/KR2023/015504

§ 371 Date: Feb. 4, 2025

(30) Foreign Application Priority Data
Nov. 11, 2022 (KR) 10-2022-0150817

(51) Int. Cl. B60H 1/00; B60H 1/14; B60H 1/32

(52) U.S. Cl. CPC B60H 1/00899; B60H 1/143; B60H 1/3207; B60H 1/3213; B60H 1/3228

(57) ABSTRACT

A vehicular heat management system is disclosed and is configured to minimize high-pressure/high-temperature movement path sections in a refrigerant movement path extending from a compressor to a chiller and a refrigerant movement path extending from the compressor to a vehicle interior cooling heat exchanger. The system includes: a heat pump type refrigerant circulation line including a compressor, a high-pressure side heat exchanger, an outdoor heat exchanger, a chiller connected in series or in parallel to the outdoor heat exchanger, and a vehicle interior cooling heat exchanger connected in series or in parallel to the outdoor heat exchanger; and a refrigerant control part configured to, in a heat pump mode, depressurize and expand a refrigerant on the compressor side and selectively allow the refrigerant to flow toward at least one of the outdoor heat exchanger, the chiller and the vehicle interior cooling heat exchanger depending on an air conditioning condition.

### TECHNICAL FIELD

The present invention relates to a vehicular heat management system, and more particularly, a vehicular heat management system configured to minimize high-pressure/high-temperature movement path sections in a refrigerant movement path extending from a compressor to a chiller and a refrigerant movement path extending from the compressor to a vehicle interior cooling heat exchanger, so that it is possible to prevent heat loss that occurs during the process of refrigerant movement from the compressor to the chiller and from the compressor to the vehicle interior cooling heat exchanger, thereby improving the heat pump efficiency and the heating and dehumidifying performance for the vehicle interior.

### BACKGROUND ART

Examples of eco-friendly vehicles include an electric vehicle, a hybrid vehicle, and a fuel cell vehicle (hereinafter collectively referred to as “vehicle”).

Such a vehicle is equipped with a heat management system for cooling and heating an air conditioning region, and the heat management system is provided with an air conditioner 10 as shown in FIG. 1.

The air conditioner 10 is of a heat pump type and includes a refrigerant circulation line 12.

The refrigerant circulation line 12 includes a compressor 14, a high-pressure side heat exchanger 16, an outdoor heat exchanger 18, a plurality of low-pressure side heat exchangers 20 installed in parallel with each other, an expansion valve 18a installed on the upstream side of the outdoor heat exchanger 18, and a plurality of expansion valves 22 and 24 installed on the upstream side of the respective low-pressure side heat exchangers 20.

The low-pressure side heat exchangers 20 include a vehicle interior cooling heat exchanger 20a for cooling the vehicle interior, and an electrical component cooling chiller 20b (hereinafter referred to as “chiller”) for cooling a battery and electrical component modules (hereinafter collectively referred to as “electrical components”).

The vehicle interior cooling heat exchanger 20a is connected in series to the outdoor heat exchanger 18 through a three-way flow control valve 25 on the upstream side thereof, or connected in parallel to the outdoor heat exchanger 18 through a branch line 12a branched from the upstream side of the expansion valve 18a on the outdoor heat exchanger 18 side.

In an air conditioning mode for cooling the vehicle interior, the vehicle interior cooling heat exchanger 20a generates a cold air by introducing the refrigerant that has been discharged from the compressor 14, passed through the high-pressure side heat exchanger 16 and the outdoor heat exchanger 18, and then depressurized and expanded by the expansion valve 22, and cools the vehicle interior with the generated cold air.

Furthermore, in a dehumidifying mode under a heat pump mode condition for heating the vehicle interior, the vehicle interior cooling heat exchanger 20a generates a cold air by introducing the refrigerant that has been discharged from the compressor 14, passed through the high-pressure side heat exchanger 16 and the branch line 12a, and then depressurized and expanded by the expansion valve 22, and dehumidifies the vehicle interior by allowing the generated cold air to exchange heat with the air in the vehicle interior.

The chiller 20b is connected in series to the outdoor heat exchanger 18 by the three-way flow control valve 25 on the upstream side thereof, or connected in parallel to the outdoor heat exchanger 18 through the branch line 12a on the upstream side of the expansion valve 18a on the outdoor heat exchanger 18 side.

In the air conditioning mode, the chiller 20b generates a cold air by introducing the refrigerant that has been discharged from the compressor 14, passed through the high-pressure side heat exchanger 16 and the outdoor heat exchanger 18, and then depressurized and expanded by the expansion valve 24, and cools the electrical components by delivering the generated cold air to the cooling water in the cooling water circulation line 26 for cooling the electrical components.

In addition, in the heat pump mode, the chiller 20b introduces the refrigerant that has been discharged from the compressor 14, passed through the high-pressure side heat exchanger 16 and the branch line 12a, and then depressurized and expanded by the expansion valve 24, and allows the introduced refrigerant to exchange heat with the cooling water in the cooling water circulation line 26 for cooling the electrical components.

Accordingly, the waste heat of the electrical components absorbed to the cooling water in the cooling water circulation line 26 can be recovered to the refrigerant in the branch line 12a. This improves the heat pump mode efficiency of the air conditioner 10.

Meanwhile, in the heat pump mode, the outdoor heat exchanger 18 introduces the refrigerant from the compressor 14 side and recovers the heat of the ambient air by allowing the introduced refrigerant to exchange heat with the ambient air.

Therefore, the heat pump mode efficiency is improved by increasing the waste heat recovery efficiency of the refrigerant returning to the compressor 14 side.

This conventional air conditioner 10 has a structure in which, in the heat pump mode, the high-temperature/high-pressure refrigerant on the compressor 14 side is moved to the expansion valve 24 on the inlet side of the chiller 20b and then depressurized and expanded. Therefore, there is a disadvantage in that the high-pressure/high-temperature refrigerant movement path section in the refrigerant movement path extending from the compressor 14 to the chiller 20b is relatively long.

In addition, in the vehicle interior dehumidifying mode under the heat pump mode condition, the high-temperature/high-pressure refrigerant on the compressor 14 side is moved to the expansion valve 22 on the inlet side of the vehicle interior cooling heat exchanger 20a and then is depressurized and expanded. Therefore, there is a disadvantage in that the high-pressure/high-temperature refrigerant movement path section in the refrigerant movement path extending from the compressor 14 to the vehicle interior cooling heat exchanger 20a is relatively long.

Due to these disadvantages, there is a problem that the heat loss rate of the refrigerant is very large during the process of moving the refrigerant from the compressor 14 to the chiller 20b and the vehicle interior cooling heat exchanger 20a.

As a result, there is a shortcoming in that the efficiency of the heat pump mode and the heating and dehumidifying performance for the vehicle interior are significantly reduced.

### DETAILED DESCRIPTION OF THE INVENTION

### Technical Task

The present invention has been made to solve the above-mentioned problems of the prior art, and it is an object of the present invention to provide a vehicular heat management system capable of, in a heat pump mode, minimizing a high-pressure/high-temperature movement path section in a refrigerant movement path extending from a compressor to a chiller.

Another object of the present invention is to provide a vehicular heat management system capable of, in a vehicle interior dehumidifying mode under a heat pump mode condition, minimizing a high-pressure/high-temperature movement path section in a refrigerant movement path extending from a compressor to a vehicle interior cooling heat exchanger.

A further object of the present invention is to provide a vehicular heat management system configured to, in a heat pump mode or a vehicle interior dehumidifying mode during a heat pump mode condition, minimize high-pressure/high-temperature movement path sections in a refrigerant movement path extending from a compressor to a chiller and a refrigerant movement path extending from the compressor to a vehicle interior cooling heat exchanger, thereby preventing heat loss that occurs during the process of refrigerant movement from the compressor to the chiller and from the compressor to the vehicle interior cooling heat exchanger.

A still further object of the present invention is to provide a vehicular heat management system configured to prevent heat loss that occurs during the process of refrigerant movement from the compressor to the chiller and from the compressor to the vehicle interior cooling heat exchanger, thereby improving the heat pump efficiency and the heating and dehumidifying performance for the vehicle interior.

### Means to Solve the Task

In order to achieve these objects, the present invention provides a vehicular heat management system, including: a heat pump type refrigerant circulation line including a compressor, a high-pressure side heat exchanger, an outdoor heat exchanger, a chiller connected in series or in parallel to the outdoor heat exchanger, and a vehicle interior cooling heat exchanger connected in series or in parallel to the outdoor heat exchanger; and a refrigerant control part configured to, in a heat pump mode, depressurize and expand a refrigerant on the compressor side and selectively allow the refrigerant to flow toward at least one of the outdoor heat exchanger, the chiller and the vehicle interior cooling heat exchanger depending on an air conditioning condition.

The outdoor heat exchanger is configured to, in the heat pump mode, allow the refrigerant of the refrigerant circulation line to exchange heat with ambient air so that the heat of the ambient air can be recovered by the refrigerant of the refrigerant circulation line, the chiller is configured to, in the heat pump mode, allow the refrigerant of the refrigerant circulation line to exchange heat with cooling water of a cooling water circulation line for cooling electrical components so that the waste heat of the electrical components absorbed to the cooling water can be recovered by the refrigerant of the refrigerant circulation line, the vehicle interior cooling heat exchanger is configured to, in a vehicle interior dehumidifying mode under a heat pump mode condition, allow the refrigerant of the refrigerant circulation line to exchange heat with vehicle interior air to dehumidify the vehicle interior, and the refrigerant control part is configured to, in the heat pump mode, depressurize and expand the refrigerant on the compressor side and allow the depressurized and expanded refrigerant to selectively flow toward at least one of the outdoor heat exchanger, the chiller and the vehicle interior cooling heat exchanger depending on the air conditioning condition, so that at least one of the recovery of air heat by the refrigerant of the outdoor heat exchanger, the recovery of waste heat of the electrical components by the refrigerant of the chiller, and the dehumidification of the vehicle interior by the vehicle interior cooling heat exchanger can be selected.

The refrigerant control part is configured to, when entering a maximum heating mode under the heat pump mode condition, depressurize and expand the refrigerant on the compressor side and then introduce the depressurized and expanded refrigerant in parallel into the outdoor heat exchanger and the chiller, so that the recovery of air heat by the refrigerant of the outdoor heat exchanger and the recovery of waste heat of the electrical components by the refrigerant of the chiller can be performed simultaneously.

The refrigerant control part is configured to, when entering the vehicle interior dehumidifying mode under a heat pump mode condition and a maximum heating mode condition, depressurize and expand the refrigerant on the compressor side and then introduce the depressurized and expanded refrigerant in series into the outdoor heat exchanger and the chiller and into the vehicle interior cooling heat exchanger, so that the recovery of air heat by the refrigerant of the outdoor heat exchanger, the recovery of waste heat of the electrical components by the refrigerant of the chiller, and the dehumidification of the vehicle interior by the vehicle interior cooling heat exchanger can be performed simultaneously.

The refrigerant control part is configured to, when entering a general heating mode under the heat pump mode condition, depressurize and expand the refrigerant on the compressor side and then introduce the depressurized and expanded refrigerant into only the chiller, so that only the recovery of waste heat of the electrical components by the refrigerant of the chiller can be performed.

The refrigerant control part is configured to, when entering the vehicle interior dehumidifying mode under the heat pump mode condition and the general heating mode condition, depressurize and expand the refrigerant on the compressor side and then introduce the depressurized and expanded refrigerant in parallel into the chiller and the vehicle interior cooling heat exchanger, so that the recovery of waste heat of the electrical components by the refrigerant of the chiller and the dehumidification of the vehicle interior by the vehicle interior cooling heat exchanger can be performed simultaneously.

The refrigerant control part is configured to, if the temperature of the cooling water of the cooling water circulation line for cooling the electrical components is equal to or lower than a preset value when entering the general heating mode under the heat pump mode condition, depressurize and expand the refrigerant on the compressor side and then introduce the depressurized and expanded refrigerant into only the outdoor heat exchanger, so that only the recovery of air heat by the refrigerant of the outdoor heat exchanger can be performed.

The refrigerant control part is configured to, when entering the vehicle interior dehumidifying mode under the heat pump mode condition and a condition in which the temperature of the cooling water of the cooling water circulation line is equal to or lower than a set temperature, depressurize and expand the refrigerant on the compressor side and then introduce the depressurized and expanded refrigerant in parallel into the outdoor heat exchanger and the vehicle interior cooling heat exchanger, so that the recovery of air heat by the refrigerant of the outdoor heat exchanger and the dehumidification of the vehicle interior by the vehicle interior cooling heat exchanger can be performed simultaneously.

The refrigerant control part includes: first and second heat pump expansion valves installed in parallel on portions of the refrigerant circulation line on the common upstream side of the outdoor heat exchanger, the vehicle interior cooling heat exchanger and the chiller, and configured to depressurize and expand the refrigerant on the compressor side; a first three-way flow control valve configured to selectively allow the refrigerant depressurized and expanded by the first heat pump expansion valve to flow toward either the outdoor heat exchanger or the chiller; a second three-way flow control valve configured to selectively allow the refrigerant depressurized and expanded by the second heat pump expansion valve to flow toward either the outdoor heat exchanger or the vehicle interior cooling heat exchanger; and a valve control part configured to, in the heat pump mode, control the first and second heat pump expansion valves and the first and second three-way flow control valves to depressurize and expand the refrigerant on the compressor side and to selectively allow the depressurized and expanded refrigerant to flow toward at least one of the outdoor heat exchanger, the chiller and the vehicle interior cooling heat exchanger depending on the air conditioning condition.

### Effect of the Invention

According to the vehicular heat management system of the present invention, in the heat pump mode, the refrigerant on the compressor side is depressurized and expanded on the common upstream side of the outdoor heat exchanger, the chiller, and the vehicle interior cooling heat exchanger, and is then supplied to a desired location.

Accordingly, unlike the related art in which the refrigerant is depressurized and expanded using the corresponding expansion valves installed in the outdoor heat exchanger and the chiller in the heat pump mode, the expansion valve for the heat pump mode can be arranged as close to the compressor as possible.

In addition, since the expansion valve for the heat pump mode can be located as close to the compressor as possible, it is possible to, in the heat pump mode, minimize the high-pressure/high-temperature movement path section in the refrigerant movement path extending from the compressor to the chiller.

In addition, since the high-pressure/high-temperature movement path section in the refrigerant movement path extending from the compressor to the chiller can be minimized in the heat pump mode, it is possible to prevent heat loss that occurs during the process of refrigerant movement from the compressor to the chiller in the heat pump mode, thereby improving the heat pump efficiency and the heating performance for the vehicle interior.

In addition, since the refrigerant on the compressor side is depressurized and expanded on the common upstream side of the outdoor heat exchanger, the chiller, and the vehicle interior cooling heat exchanger, and is then supplied to a desired location in the heat pump mode, unlike the related art in which the refrigerant is depressurized and expanded using the expansion valve on the inlet side of the vehicle interior cooling heat exchanger in the vehicle interior dehumidifying mode under the heat pump mode condition, the expansion valve for the vehicle interior dehumidifying mode under the heat pump mode condition can be arranged as close to the compressor as possible.

In addition, since the expansion valve for the vehicle interior dehumidifying mode under the heat pump mode condition can be arranged as close to the compressor as possible, it is possible to, in the vehicle interior dehumidifying mode under the heat pump mode condition, minimize the high-pressure/high-temperature movement path section in the refrigerant movement path extending from the compressor to the vehicle interior cooling heat exchanger.

In addition, since the high-pressure/high-temperature movement path section in the refrigerant movement path extending from the compressor to the vehicle interior cooling heat exchanger can be minimized in the vehicle interior dehumidifying mode under the heat pump mode condition, it is possible to, in the vehicle interior dehumidifying mode under the heat pump mode condition, prevent heat loss that occurs during the process of refrigerant movement from the compressor to the vehicle interior cooling heat exchanger, thereby improving the heat pump efficiency and the dehumidifying performance for the vehicle interior.

### BRIEF DESCRIPTION OF THE DRAWINGS

FIG. 1 is a view showing a conventional vehicular heat management system.

FIG. 2 is a view showing a vehicular heat management system according to the present invention.

FIG. 3 is an operation diagram of the vehicular heat management system according to the present invention, showing an operation example when entering a maximum heating mode under a heat pump mode condition.

FIG. 4 is an operation diagram of the vehicular heat management system according to the present invention, showing an operation example when entering a vehicle interior dehumidifying mode under a heat pump mode condition and a maximum heating mode condition.

FIG. 5 is an operation diagram of the vehicular heat management system according to the present invention, showing an operation example when entering a general heating mode under a heat pump mode condition.

FIG. 6 is an operation diagram of the vehicular heat management system according to the present invention, showing an operation example when entering a vehicle interior dehumidifying mode under a heat pump mode condition and a general heating mode condition.

FIG. 7 is an operation diagram of the vehicular heat management system according to the present invention, showing an operation example in a case in which the cooling water temperature in a cooling water circulation line for cooling electrical components is lower than a preset level when entering a general heating mode under a heat pump mode condition.

FIG. 8 is an operation diagram of the vehicular heat management system according to the present invention, showing an operation example when entering a vehicle interior dehumidifying mode under a heat pump mode condition, a general heating mode condition, and a condition in which the cooling water in the cooling water circulation line has a temperature equal to or lower than a preset temperature.

FIG. 9 is an operation diagram of the vehicular heat management system according to the present invention, showing an operation example in an air conditioning mode.

### BEST MODE TO IMPLEMENT THE INVENTION

Hereinafter, a preferred embodiment of a vehicular heat management system according to the present invention will be described in detail with reference to the accompanying drawings. The same components as those of the above-described prior art will be designated by the same reference numerals.

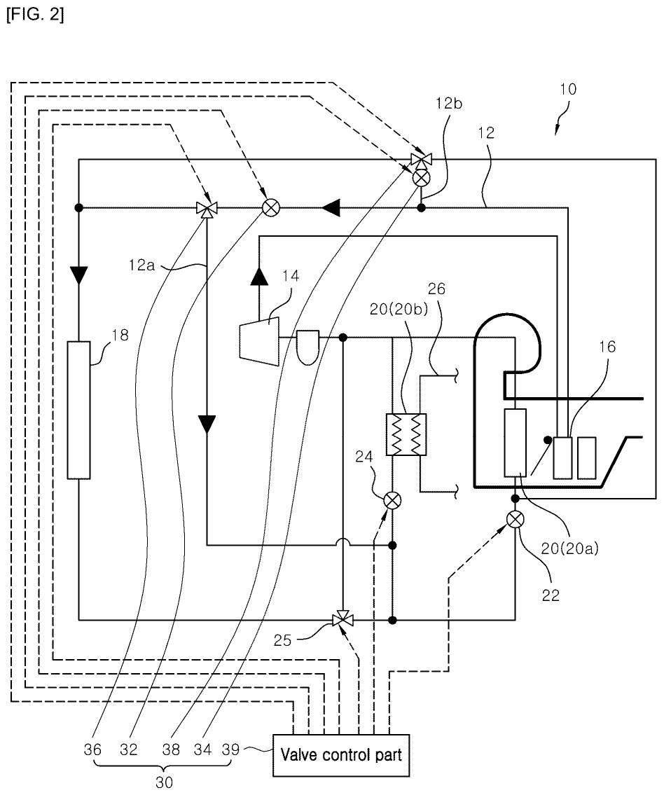

First, prior to describing the features of the vehicular heat management system according to the present invention, the general aspect of the vehicular heat management system will be briefly described with reference to FIG. 2.

The vehicular heat management system is equipped with an air conditioner 10 that cools and heats an air conditioning region. The air conditioner 10 is of a heat pump type and includes a refrigerant circulation line 12.

The refrigerant circulation line 12 includes a compressor 14, a high-pressure side heat exchanger 16, an outdoor heat exchanger 18, a plurality of low-pressure side heat exchangers 20 installed in parallel with each other, and a plurality of electromagnetic variable expansion valves 22 and 24 installed on the upstream side of the respective low-pressure side heat exchangers 20.

The low-pressure side heat exchangers 20 include a vehicle interior cooling heat exchanger 20a for cooling the vehicle interior, and a chiller for cooling electrical components.

The vehicle interior cooling heat exchanger 20a is connected in series to the outdoor heat exchanger 18 through a three-way flow control valve 25 on the upstream side thereof, or connected in parallel to the outdoor heat exchanger 18 through a branch line 12a on the upstream side of the outdoor heat exchanger 18 in some cases.

The chiller 20b is connected in series to the outdoor heat exchanger 18 by the three-way flow control valve 25 on the upstream side thereof, or connected in parallel to the outdoor heat exchanger 18 through the branch line 12a on the upstream side of the expansion valve 18a on the outdoor heat exchanger 18 side in some cases.

In the heat pump mode, the chiller 20b introduces the refrigerant that has been discharged from the compressor 14, passed through the high-pressure side heat exchanger 16 and the branch line 12a, and then depressurized and expanded by the expansion valve 24, and allows the introduced refrigerant to exchange heat with the cooling water in the cooling water circulation line 26 for cooling the electrical components.

Accordingly, the waste heat (hereinafter referred to as “water heat”) of the electrical components absorbed to the cooling water in the cooling water circulation line 26 can be recovered to the refrigerant in the branch line 12a. This improves the heat pump mode efficiency of the air conditioner 10.

Meanwhile, in the heat pump mode, the outdoor heat exchanger 18 introduces the refrigerant from the compressor 14 and recovers the ambient air heat by allowing the introduced refrigerant to exchange heat with the ambient air.

Therefore, the waste heat recovery efficiency for the refrigerant returned to the compressor 14 can be increased, thereby improving the heat pump mode efficiency.

Next, the features of the vehicular heat management system according to the present invention will be described in detail with reference to FIGS. 2 to 6.

Referring first to FIG. 2, the heat management system of the present invention includes a refrigerant control part 30 configured to, in the heat pump mode, decompress and expand the refrigerant on the compressor 14 side and selectively allow the refrigerant to flow toward at least one of the outdoor heat exchanger 18, the chiller 20b, and the vehicle interior cooling heat exchanger 20a depending on an air conditioning condition.

The refrigerant control part 30 includes first and second heat pump expansion valves 32 and 34 installed in parallel in the portion of the upstream refrigerant circulation line 12 common to the outdoor heat exchanger 18, the vehicle interior cooling heat exchanger 20a and the chiller 20b, first and second three-way flow control valves 36 and 38 configured to selectively allow the refrigerant, which has been decompressed and expanded in the first and second heat pump expansion valves 32 and 34, to flow toward at least one of the outdoor heat exchanger 18, the chiller 20b and the vehicle interior cooling heat exchanger 20a, and a valve control part 39 configured to control the valves 32, 34, 36 and 38.

The first and second heat pump expansion valves 32 and 34 are electromagnetic variable expansion valves, and are installed in parallel in the portion of the refrigerant circulation line 12 common to the outdoor heat exchanger 18, the vehicle interior cooling heat exchanger 20a and the chiller 20b, for example, in the portion of the refrigerant circulation line 12 between the high-pressure side heat exchanger 16 and the branch line 12a.

In particular, the first heat pump expansion valve 32 is installed on the refrigerant circulation line 12 between the high-pressure side heat exchanger 16 and the branch line 12a, and the second heat pump expansion valve 34 is installed on the second branch line 12b branched between the high-pressure side heat exchanger 16 and the branch line 12a.

The first and second heat pump expansion valves 32 and 34 are arranged in parallel with respect to the compressor 14 and the high-pressure side heat exchanger 16.

The first and second heat pump expansion valves 32 and 34 arranged in this manner depressurize and expand the refrigerant on the compressor 14 side before the refrigerant is introduced into the outdoor heat exchanger 18, the chiller 20b and the vehicle interior cooling heat exchanger 20a.

The first and second three-way flow control valves 36 and 38 are installed on the downstream sides of the first and second heat pump expansion valves 32 and 34 in a one-to-one correspondence relationship.

The first and second three-way flow control valves 36 and 38 control the flow direction of the refrigerant, which has been depressurized and expanded by the first and second heat pump expansion valves 32 and 34, so that the refrigerant can flow toward at least one of the outdoor heat exchanger 18, the chiller 20b and the vehicle interior cooling heat exchanger 20a.

The first three-way flow control valve 36 is installed at a branch point of the branch line 12a on the downstream side of the first heat pump expansion valve 32, and is configured to selectively allow the refrigerant, which has been depressurized and expanded in the first heat pump expansion valve 32, to flow toward either the outdoor heat exchanger 18 or the chiller 20b.

The second three-way flow control valve 38 is installed on the downstream side of the second heat pump expansion valve 34, and is configured to selectively allow the refrigerant, which has been depressurized and expanded by the second heat pump expansion valve 34, to flow toward either the outdoor heat exchanger 18 or the vehicle interior cooling heat exchanger 20a.

It is preferable that the second three-way flow control valve 38 has an expansion valve-integrated structure in which the second three-way flow control valve 38 is formed integrally with the second heat pump expansion valve 34.

In the heat pump mode, the valve control part 39 controls at least one of the first and second heat pump expansion valves 32 and 34 depending on an air conditioning condition to depressurize and expand the refrigerant on the compressor 14 side.

In addition, the valve control part 39 controls the first and second three-way flow control valves 36 and 38 to allow the refrigerant, which has been depressurized and expanded by at least one of the first and second heat pump expansion valves 32 and 34, to flow toward at least one of the outdoor heat exchanger 18, the chiller 20b and the vehicle interior cooling heat exchanger 20a.

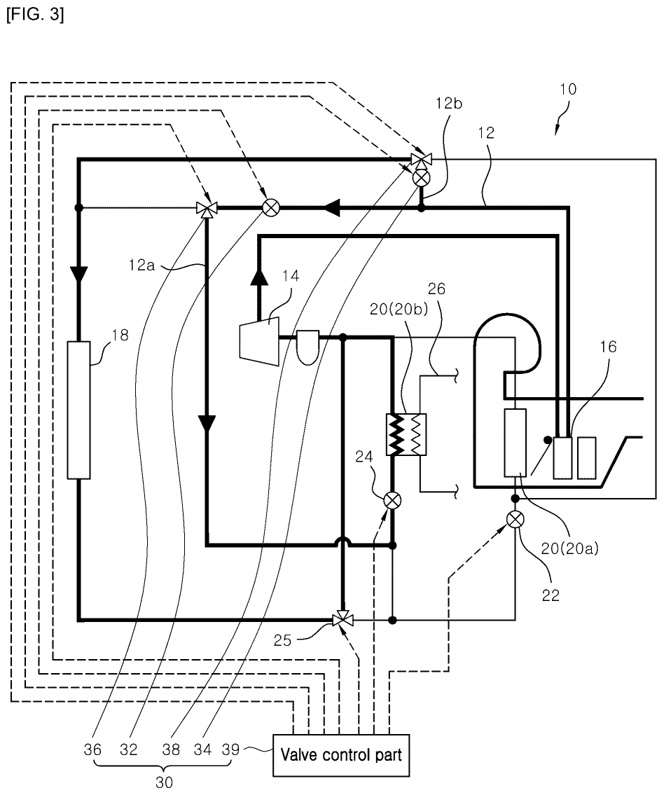

For example, as shown in FIG. 3, when entering a maximum heating mode under a heat pump mode condition, the valve control part 39 turns on all of the first and second heat pump expansion valves 32 and 34, so that the refrigerant on the compressor 14 side can be depressurized and expanded by the first and second heat pump expansion valves 32 and 34.

In addition, the valve control part 39 controls the first and second three-way flow control valves 36 and 38, so that the refrigerant depressurized and expanded by the first heat pump expansion valve 32 can be introduced into the chiller 20b, and the refrigerant depressurized and expanded by the second heat pump expansion valve 34 can be introduced into the outdoor heat exchanger 18.

Therefore, when entering the maximum heating mode under the heat pump mode condition, the refrigerant depressurized and expanded on the upstream side of the outdoor heat exchanger 18 and the chiller 20b can flow in parallel toward the outdoor heat exchanger 18 and the chiller 20b.

Thus, the recovery of air heat through the refrigerant flow toward the outdoor heat exchanger 18 and the recovery of water heat through the refrigerant flow toward the chiller 20b of the cooling water circulation line 26 for cooling the electrical components can be performed simultaneously.

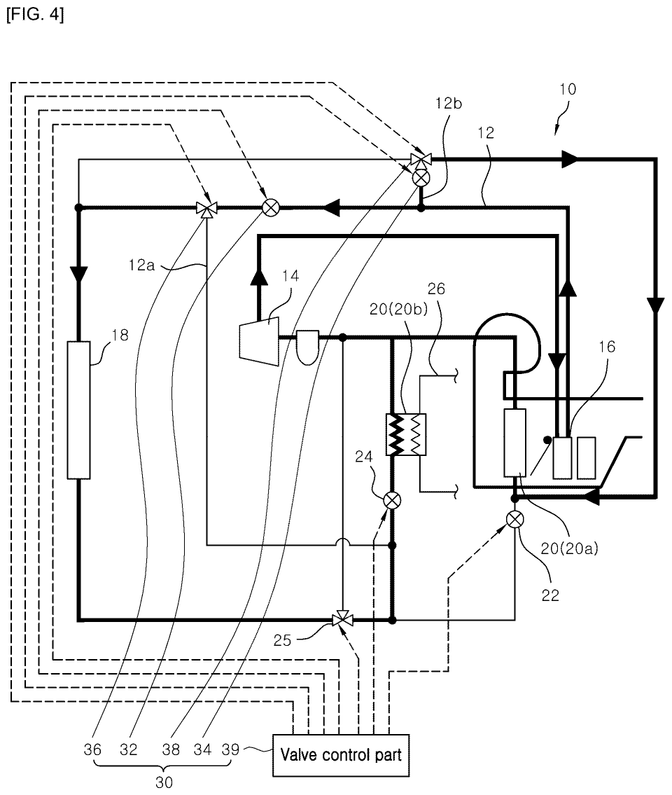

In addition, as shown in FIG. 4, when entering a vehicle interior dehumidifying mode under the heat pump mode condition and the maximum heating mode condition, the valve control part 39 turns on all of the first and second heat pump expansion valves 32 and 34, so that the refrigerant on the compressor 14 side can be depressurized and expanded by the first and second heat pump expansion valves 32 and 34.

In addition, the valve control part 39 controls the first and second three-way flow control valves 36 and 38, so that the refrigerant depressurized and expanded by the first heat pump expansion valve 32 can be introduced into the outdoor heat exchanger 18, and the refrigerant depressurized and expanded by the second heat pump expansion valve 34 can be introduced into the vehicle interior cooling heat exchanger 20a.

Therefore, when entering the vehicle interior dehumidifying mode under the heat pump mode condition and the maximum heating mode condition, the valve control part 39 allows the refrigerant depressurized and expanded on the upstream sides of the outdoor heat exchanger 18, the chiller 20b and the vehicle interior cooling heat exchanger 20a to flow in parallel toward the outdoor heat exchanger 18 and the vehicle interior cooling heat exchanger 20a.

As a result, the refrigerant flowing toward the outdoor heat exchanger 18 can recover the ambient air heat, and the refrigerant flowing toward the vehicle interior cooling heat exchanger 20a can dehumidify the vehicle interior.

The valve control part 39 is configured to control the three-way flow control valve 25 between the outdoor heat exchanger 18 and the chiller 20b to connect the outdoor heat exchanger 18 and the chiller 20b in series.

Therefore, the refrigerant flowing toward the outdoor heat exchanger 18 can flow toward the chiller 20b, thereby recovering the water heat of the cooling water circulation line 26 for cooling the electrical components.

Thus, when entering the vehicle interior dehumidifying mode under the heat pump mode condition and the maximum heating mode condition, the recovery of air heat on the outdoor heat exchanger 18 side and the recovery of water heat on the chiller 20b side can be performed one after another.

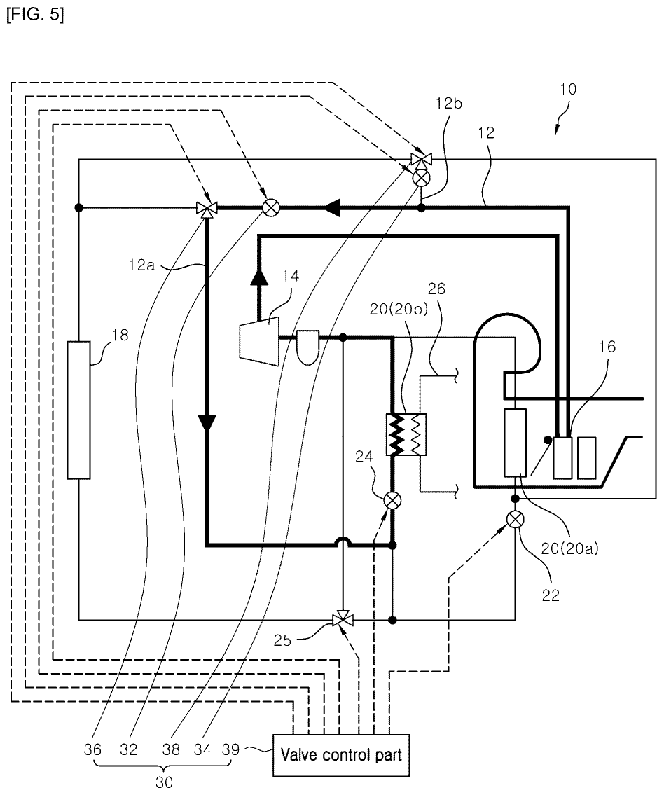

As shown in FIG. 5, when entering a general heating mode under the heat pump mode condition, the valve control part 39 turns on the first heat pump expansion valve 32, and turns off the second heat pump expansion valve 34, so that the refrigerant on the compressor 14 side can be depressurized and expanded only by the first heat pump expansion valve 32.

In addition, the valve control part 39 controls the first three-way flow control valve 36, so that the refrigerant depressurized and expanded by the first heat pump expansion valve 32 can be introduced into the chiller 20b.

Therefore, when entering the general heating mode under the heat pump mode condition, the refrigerant depressurized and expanded on the upstream sides of the outdoor heat exchanger 18, the chiller 20b and the vehicle interior cooling heat exchanger 20a can flow only to the chiller 20b.

As a result, the refrigerant flowing toward the chiller 20b can recover the water heat of the cooling water circulation line 26 for cooling the electrical components.

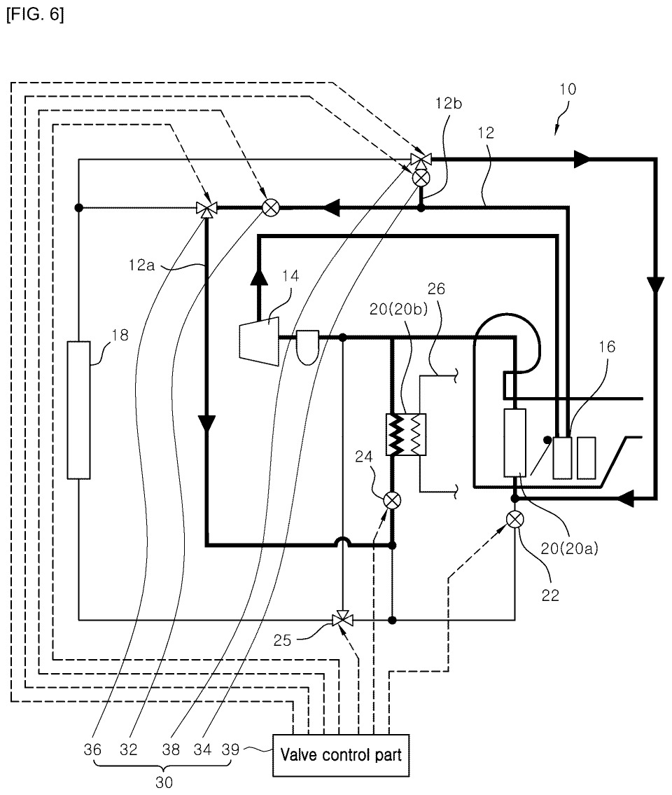

As shown in FIG. 6, when entering the vehicle interior dehumidifying mode under the heat pump mode condition and the general heating mode condition, the valve control part 39 turns on the first and second heat pump expansion valves 32 and 34, so that the refrigerant on the compressor 14 side can be depressurized and expanded by the first and second heat pump expansion valves 32 and 34.

In addition, the valve control part 39 controls the first and second three-way flow control valves 36 and 38, so that the refrigerant depressurized and expanded by the first heat pump expansion valve 32 can be introduced into the chiller 20b, and the refrigerant depressurized and expanded by the second heat pump expansion valve 34 can be introduced into the vehicle interior cooling heat exchanger 20a.

Therefore, when entering the vehicle interior dehumidifying mode under the heat pump mode condition and the general heating mode condition, the refrigerant depressurized and expanded on the upstream sides of the outdoor heat exchanger 18, the chiller 20b and the vehicle interior cooling heat exchanger 20a can flow in parallel toward the chiller 20b and the vehicle interior cooling heat exchanger 20a.

As a result, the refrigerant flowing toward the chiller 20b can recover the water heat of the cooling water circulation line 26 for cooling the electric components, and the refrigerant flowing toward the vehicle interior cooling heat exchanger 20a can dehumidify the vehicle interior.

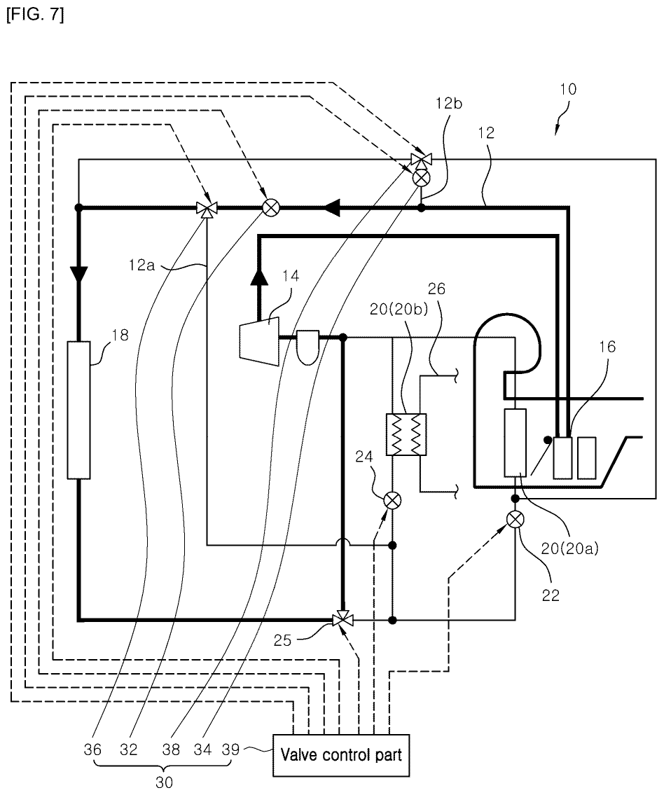

As shown in FIG. 7, when entering the general heating mode under the heat pump mode condition, if the cooling water temperature of the cooling water circulation line 26 for cooling the electrical components is lower than a preset value, the valve control part 39 turns on the first heat pump expansion valve 32, and turns off the second heat pump expansion valve 34, so that the refrigerant on the compressor 14 side can be depressurized and expanded only by the first heat pump expansion valve 32.

In addition, the valve control part 39 controls the first three-way flow control valve 36, so that the refrigerant depressurized and expanded by the first heat pump expansion valve 32 can be introduced into the outdoor heat exchanger 18.

Therefore, when entering the general heating mode under the heat pump mode condition, if the cooling water temperature of the cooling water circulation line 26 for cooling the electric components is lower than the set value, the refrigerant depressurized and expanded on the upstream sides of the outdoor heat exchanger 18, the chiller 20b and the vehicle interior cooling heat exchanger 20a is allowed to flow toward only the outdoor heat exchanger 18.

As a result, the refrigerant flowing toward the outdoor heat exchanger 18 can recover the ambient air heat.

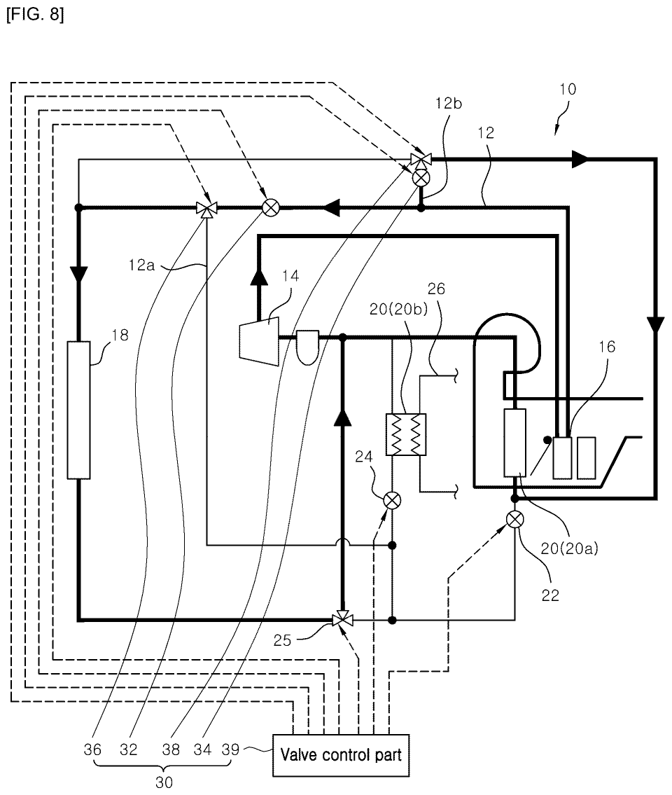

As shown in FIG. 8, when entering the vehicle interior dehumidifying mode under the heat pump mode condition, the general heating mode condition, and the condition in which the cooling water temperature of the coolant circulation line 26 is equal to or lower than a set temperature, the valve control part 39 turns on all of the first and second heat pump expansion valves 32 and 34, so that the refrigerant on the compressor 14 side can be depressurized and expanded by the first and second heat pump expansion valves 32 and 34.

In addition, the valve control part 39 controls the first and second three-way flow control valves 36 and 38, so that the refrigerant depressurized and expanded by the first heat pump expansion valve 32 can be introduced into the outdoor heat exchanger 18, and the refrigerant depressurized and expanded by the second heat pump expansion valve 34 can be introduced into the vehicle interior cooling heat exchanger 20a.

Therefore, when entering the vehicle interior dehumidifying mode under the heat pump mode condition, the general heating mode condition, and the condition in which the cooling water temperature of the coolant circulation line 26 is equal to or lower than the set temperature, the refrigerant depressurized and expanded on the upstream sides of the outdoor heat exchanger 18, the chiller 20b and the vehicle interior cooling heat exchanger 20a can flow in parallel toward the outdoor heat exchanger 18 and the vehicle interior cooling heat exchanger 20a.

As a result, the refrigerant flowing toward the outdoor heat exchanger 18 can recover the ambient air heat, and the refrigerant flowing toward the vehicle interior cooling heat exchanger 20a can dehumidify the vehicle interior.

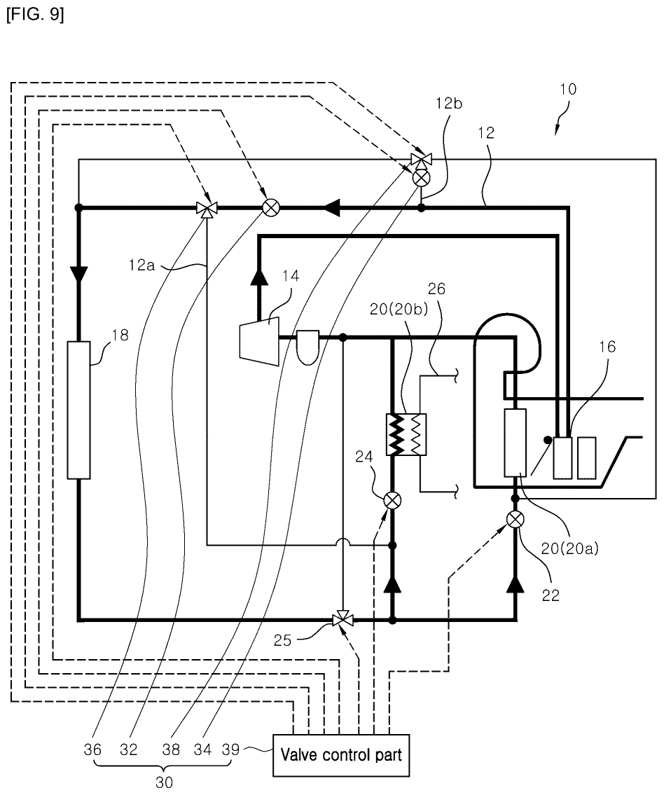

Meanwhile, in the air conditioner mode, as shown in FIG. 9, the valve control part 39 controls the first heat pump expansion valve 32 to be fully open, and turns off the second heat pump expansion valve 34.

In addition, the valve control part 39 controls the first three-way flow control valve 36 so that the refrigerant passed through the first heat pump expansion valve 32 without depressurization and expansion can be introduced into the outdoor heat exchanger 18, and controls the three-way flow control valve 25 on the downstream side of the outdoor heat exchanger 18 so that the outdoor heat exchanger 18, the chiller 20b and the vehicle interior cooling heat exchanger 20a can be connected to each other.

Accordingly, the refrigerant passing through the outdoor heat exchanger 18 can be depressurized and expanded while passing through the expansion valve 24 on the chiller 20b side and the expansion valve 22 on the vehicle interior cooling heat exchanger 20a side.

The depressurized and expanded refrigerant is introduced into the chiller 20b and the vehicle interior cooling heat exchanger 20a, thereby cooling the electrical components and the vehicle interior.

According to the vehicular heat management system of the present invention configured as described above, in the heat pump mode, the refrigerant on the compressor 14 side is depressurized and expanded on the common upstream side of the outdoor heat exchanger 18, the chiller 20b, and the vehicle interior cooling heat exchanger 20a, and is then supplied to a desired location.

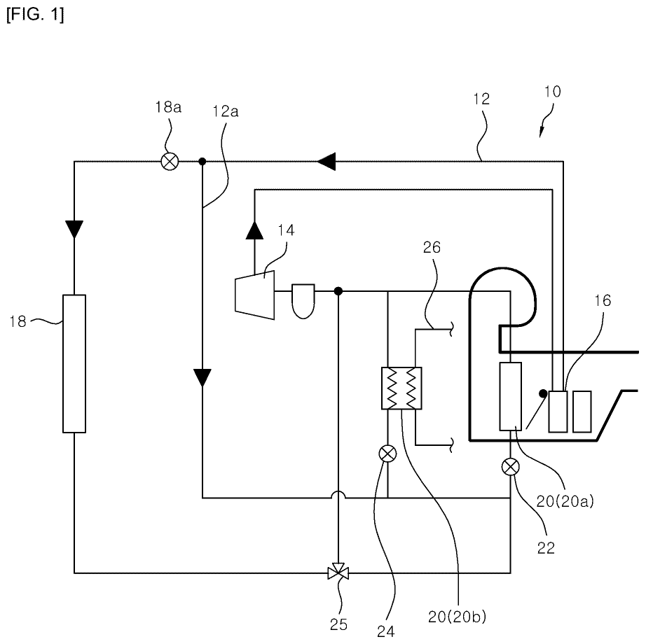

Accordingly, unlike the related art in which the refrigerant is depressurized and expanded using the corresponding expansion valves 18a and 24 (see FIG. 1) installed in the outdoor heat exchanger 18 and the chiller 20b in the heat pump mode, the expansion valve for the heat pump mode can be arranged as close to the compressor 14 as possible.

In addition, since the expansion valve for the heat pump mode can be located as close to the compressor 14 as possible, it is possible to, in the heat pump mode, minimize the high-pressure/high-temperature movement path section in the refrigerant movement path extending from the compressor 14 to the chiller 20b.

In addition, since the high-pressure/high-temperature movement path section in the refrigerant movement path extending from the compressor 14 to the chiller 20b can be minimized in the heat pump mode, it is possible to prevent heat loss that occurs during the process of refrigerant movement from the compressor 14 to the chiller 20b in the heat pump mode, thereby improving the heat pump efficiency and the heating performance for the vehicle interior.

In addition, since the refrigerant on the compressor 14 side is depressurized and expanded on the common upstream side of the outdoor heat exchanger 18, the chiller 20b, and the vehicle interior cooling heat exchanger 20a, and is then supplied to a desired location in the heat pump mode, unlike the related art in which the refrigerant is depressurized and expanded using the expansion valve 24 on the inlet side of the vehicle interior cooling heat exchanger 20a in the vehicle interior dehumidifying mode under the heat pump mode condition, the expansion valve for the vehicle interior dehumidifying mode under the heat pump mode condition can be arranged as close to the compressor 14 as possible.

In addition, since the expansion valve for the vehicle interior dehumidifying mode under the heat pump mode condition can be arranged as close to the compressor 14 as possible, it is possible to, in the vehicle interior dehumidifying mode under the heat pump mode condition, minimize the high-pressure/high-temperature movement path section in the refrigerant movement path extending from the compressor 14 to the vehicle interior cooling heat exchanger 20a.

In addition, since the high-pressure/high-temperature movement path section in the refrigerant movement path extending from the compressor 14 to the vehicle interior cooling heat exchanger 20a can be minimized in the vehicle interior dehumidifying mode under the heat pump mode condition, it is possible to, in the vehicle interior dehumidifying mode under the heat pump mode condition, prevent heat loss that occurs during the process of refrigerant movement from the compressor 14 to the vehicle interior cooling heat exchanger 20a, thereby improving the heat pump efficiency and the dehumidifying performance for the vehicle interior.

While the preferred embodiment of the present invention has been described above by way of example, the scope of the present invention is not limited to such as specific embodiment, and may be appropriately changed within the scope recited in the claims.

1. A vehicular heat management system, comprising:
a heat pump type refrigerant circulation line including a compressor, a high-pressure side heat exchanger, an outdoor heat exchanger, a chiller connected in series or in parallel to the outdoor heat exchanger, and a vehicle interior cooling heat exchanger connected in series or in parallel to the outdoor heat exchanger; and
a refrigerant control part configured to, in a heat pump mode, depressurize and expand a refrigerant on the compressor side and selectively allow the refrigerant to flow toward at least one of the outdoor heat exchanger, the chiller and the vehicle interior cooling heat exchanger depending on an air conditioning condition.

2. The system of claim 1, wherein the outdoor heat exchanger is configured to, in the heat pump mode, allow the refrigerant of the refrigerant circulation line to exchange heat with ambient air so that the heat of the ambient air can be recovered by the refrigerant of the refrigerant circulation line,
the chiller is configured to, in the heat pump mode, allow the refrigerant of the refrigerant circulation line to exchange heat with cooling water of a cooling water circulation line for cooling electrical components so that waste heat of the electrical components absorbed to the cooling water can be recovered by the refrigerant of the refrigerant circulation line,
the vehicle interior cooling heat exchanger is configured to, in a vehicle interior dehumidifying mode under a heat pump mode condition, allow the refrigerant of the refrigerant circulation line to exchange heat with vehicle interior air to dehumidify the vehicle interior, and
the refrigerant control part is configured to, in the heat pump mode, depressurize and expand the refrigerant on the compressor side and allow the depressurized and expanded refrigerant to selectively flow toward at least one of the outdoor heat exchanger, the chiller and the vehicle interior cooling heat exchanger depending on the air conditioning condition, so that at least one of the recovery of air heat by the refrigerant of the outdoor heat exchanger, the recovery of waste heat of the electrical components by the refrigerant of the chiller, and the dehumidification of the vehicle interior by the vehicle interior cooling heat exchanger can be selected.

3. The system of claim 2, wherein the refrigerant control part is configured to, when entering a maximum heating mode under the heat pump mode condition, depressurize and expand the refrigerant on the compressor side and then introduce the depressurized and expanded refrigerant in parallel into the outdoor heat exchanger and the chiller, so that the recovery of air heat by the refrigerant of the outdoor heat exchanger and the recovery of waste heat of the electrical components by the refrigerant of the chiller can be performed simultaneously.

4. The system of claim 3, wherein the refrigerant control part is configured to, when entering the vehicle interior dehumidifying mode under a heat pump mode condition and a maximum heating mode condition, depressurize and expand the refrigerant on the compressor side and then introduce the depressurized and expanded refrigerant in series into the outdoor heat exchanger and the chiller and into the vehicle interior cooling heat exchanger, so that the recovery of air heat by the refrigerant of the outdoor heat exchanger, the recovery of waste heat of the electrical components by the refrigerant of the chiller, and the dehumidification of the vehicle interior by the vehicle interior cooling heat exchanger can be performed simultaneously.

5. The system of claim 4, wherein the refrigerant control part is configured to, when entering a general heating mode under the heat pump mode condition, depressurize and expand the refrigerant on the compressor side and then introduce the depressurized and expanded refrigerant into only the chiller, so that only the recovery of waste heat of the electrical components by the refrigerant of the chiller can be performed.

6. The system of claim 5, wherein the refrigerant control part is configured to, when entering the vehicle interior dehumidifying mode under the heat pump mode condition and the general heating mode condition, depressurize and expand the refrigerant on the compressor side and then introduce the depressurized and expanded refrigerant in parallel into the chiller and the vehicle interior cooling heat exchanger, so that the recovery of waste heat of the electrical components by the refrigerant of the chiller and the dehumidification of the vehicle interior by the vehicle interior cooling heat exchanger can be performed simultaneously.

7. The system of claim 6, wherein the refrigerant control part is configured to, if the temperature of the cooling water of the cooling water circulation line for cooling the electrical components is equal to or lower than a preset value when entering the general heating mode under the heat pump mode condition, depressurize and expand the refrigerant on the compressor side and then introduce the depressurized and expanded refrigerant into only the outdoor heat exchanger, so that only the recovery of air heat by the refrigerant of the outdoor heat exchanger can be performed.

8. The system of claim 7, wherein the refrigerant control part is configured to, when entering the vehicle interior dehumidifying mode under the heat pump mode condition and a condition in which the temperature of the cooling water of the cooling water circulation line is equal to or lower than a set temperature, depressurize and expand the refrigerant on the compressor side and then introduce the depressurized and expanded refrigerant in parallel into the outdoor heat exchanger and the vehicle interior cooling heat exchanger, so that the recovery of air heat by the refrigerant of the outdoor heat exchanger and the dehumidification of the vehicle interior by the vehicle interior cooling heat exchanger can be performed simultaneously.

9. The system of claim 8, wherein the refrigerant control part includes:
first and second heat pump expansion valves installed in parallel on portions of the refrigerant circulation line on the common upstream side of an outdoor heat exchanger, a vehicle interior cooling heat exchanger and a chiller, and configured to depressurize and expand the refrigerant on the compressor side;
a first three-way flow control valve configured to selectively allow the refrigerant depressurized and expanded by the first heat pump expansion valve to flow toward either the outdoor heat exchanger or the chiller;
a second three-way flow control valve configured to selectively allow the refrigerant depressurized and expanded by the second heat pump expansion valve to flow toward either the outdoor heat exchanger or the vehicle interior cooling heat exchanger; and
a valve control part configured to, in the heat pump mode, control the first and second heat pump expansion valves and the first and second three-way flow control valves to depressurize and expand the refrigerant on the compressor side and to selectively allow the depressurized and expanded refrigerant to flow toward at least one of the outdoor heat exchanger, the chiller and the vehicle interior cooling heat exchanger depending on an air conditioning condition.

10. The system of claim 9, wherein the valve control part is configured to, when entering the maximum heating mode under the heat pump mode condition, turn on the first and second heat pump expansion valves so that the refrigerant on the compressor side can be depressurized and expanded by the first and second heat pump expansion valves, and control the first and second three-way flow control valves so that the refrigerant depressurized and expanded by the first heat pump expansion valve can be introduced into the chiller, and the refrigerant depressurized and expanded by the second heat pump expansion valve can be introduced into the outdoor heat exchanger.

11. The system of claim 10, wherein the valve control part is configured to, when entering the vehicle interior humidifying mode under the heat pump mode condition and the maximum heating mode condition, turn on the first and second heat pump expansion valves so that the refrigerant on the compressor side can be depressurized and expanded by the first and second heat pump expansion valves, and control the first and second three-way flow control valves and a three-way flow control valve for connecting the outdoor heat exchanger and the chiller in series, so that the refrigerant depressurized and expanded by the first heat pump expansion valve can be introduced into the chiller through the outdoor heat exchanger, and the refrigerant depressurized and expanded by the second heat pump expansion valve can be introduced into the vehicle interior cooling heat exchanger.

12. The system of claim 11, wherein the valve control part is configured to, when entering the general heating mode under the heat pump mode condition, turn on the first heat pump expansion valve and turn off the second heat pump expansion valve so that the refrigerant on the compressor side can be depressurized and expanded by only the first heat pump expansion valve, and control the first three-way flow control valve so that the refrigerant depressurized and expanded by the first heat pump expansion valve can be introduced into the chiller.

13. The system of claim 12, wherein the valve control part is configured to, when entering the vehicle interior humidifying mode under the heat pump mode condition and the general heating mode condition, turn on the first and second heat pump expansion valves so that the refrigerant on the compressor side can be depressurized and expanded by the first and second heat pump expansion valves, and control the first and second three-way flow control valves so that the refrigerant depressurized and expanded by the first heat pump expansion valve can be introduced into the chiller, and the refrigerant depressurized and expanded by the second heat pump expansion valve can be introduced into the vehicle interior cooling heat exchanger.

14. The system of claim 13, wherein the valve control part is configured to, if the temperature of the cooling water of the cooling water circulation line for cooling the electrical components is equal to or lower than a preset value when entering the general heating mode under the heat pump mode condition, turn on the first heat pump expansion valve and turn off the second heat pump expansion valve so that the refrigerant on the compressor side can be depressurized and expanded by only the first heat pump expansion valve, and control the first three-way flow control valve so that the refrigerant depressurized and expanded by the first heat pump expansion valve can be introduced into the outdoor heat exchanger.

15. The system of claim 14, wherein the valve control part is configured to, when entering the vehicle interior dehumidifying mode under the heat pump mode condition and the condition in which the temperature of the cooling water of the cooling water circulation line is equal to or lower than a set temperature, turn on the first and second heat pump expansion valves so that the refrigerant on the compressor side can be depressurized and expanded by the first and second heat pump expansion valves, and control the first and second three-way flow control valves so that the refrigerant depressurized and expanded by the first heat pump expansion valve can be introduced into the outdoor heat exchanger, and the refrigerant depressurized and expanded by the second heat pump expansion valve can be introduced into the vehicle interior cooling heat exchanger.

16. The system of claim 9, wherein the second heat pump expansion valve and the second three-way flow control valve are integrally formed as one body.
